(19) United States
(12) Patent Application Publication
(10) Pub. No.: US 2024/0174126 A1
(43) Pub. Date: May 30, 2024

(54) BATTERY MANAGEMENT SYSTEM, CONTROL SYSTEM AND ELECTRIC VEHICLE HAVING BATTERY MANAGEMENT SYSTEM

(71) Applicant: Nanointech Co., Ltd., Gangwon-do (KR)

(72) Inventor: Su Hun KIM, Incheon (KR)

(73) Assignee: Nanointech Co., Ltd., Gangwon-do (KR)

(21) Appl. No.: 18/156,392

(22) Filed: Jan. 19, 2023

(30) Foreign Application Priority Data
Nov. 25, 2022 (KR) 10-2022-0160062

(51) Int. Cl. B60L 58/16; B60L 58/12

(52) U.S. Cl. CPC B60L 58/16; B60L 58/12; B60L 2240/14; B60L 2240/427; B60L 2240/429; B60L 2250/26

(57) ABSTRACT

An electric vehicle includes: a motor driving the electric vehicle; an accelerator pedal configured to receive a force from a driver and generate a first accelerator signal corresponding to the force; a battery configured to drive the motor, the battery including a battery management system configured to receive the first accelerator signal from the accelerator pedal and generate a second accelerator signal; and a control unit configured to receive the second accelerator signal from the battery management system, and to control the motor and adjust an output of the battery based on the second accelerator signal.

### TECHNICAL FIELD

The present disclosure relates to a battery management system (BMS), an electric vehicle control system including the battery management system, and an electric vehicle, and more particularly, to a battery management system having the same effect as derating, an electric vehicle control system including the battery management system, and an electric vehicle, in an environment where the BMS of the battery and a motor control system (MCU) of the electric vehicle may not communicate.

### BACKGROUND

Derating is a method of receiving, by a microcontroller unit (MCU), a maximum current value from a battery management system (BMS) according to power maps or state of charge (SOC) maps of each battery cell included in a battery to limit and adjust a maximum output for each temperature of battery cells and for each SOC situation. The BMS a maximum allowable current (or power) for each SOC and each temperature, and transmits the information on the maximum allowable current (or power) to the MCU so that the MCU does not output a current higher than the upper limit. To this end, the BMS and the MCU need to communicate, and typically, the BMS and the MCU are communicatively connected through a communication channel such as a controller area network (CAN).

When replacing (removing) an existing battery with (from) a different type of batteries, it is difficult to form a communication channel between the BMS and the MCU of the electric vehicle. Therefore, a new communication method is required for derating of a battery.

### RELATED ART DOCUMENT

### Patent Document

Korean Patent Publication No. 10-2325508
Korean Patent Publication No. 10-2123675
Korean Patent Laid-Open Publication No. 10-2006-0069136

### SUMMARY

The present disclosure provides a battery management system having the same effect as derating in an electric vehicle in which it is difficult to form a complex communication channel with a BMS and an MCU of the electric vehicle, an electric vehicle control system including the battery management system, and an electric vehicle.

In one general aspect, an electric vehicle may include: a motor driving the electric vehicle; an accelerator pedal configured to receive a force from a driver and generate a first accelerator signal corresponding to the force; a battery configured to drive the motor, the battery including a battery management system configured to receive the first accelerator signal from the accelerator pedal and generate a second accelerator signal; and a control unit configured to receive the second accelerator signal from the battery management system, and to control the motor and adjust an output of the battery based on the second accelerator signal.

The first accelerator signal and the second accelerator signal may be the same type of signals.

The second accelerator signal may be smaller than the first accelerator signal.

The battery management system may generate the second accelerator signal based on state information of the battery.

The state information of the battery may include at least one of a state of health (SOH), a state of charge (SOC), a state of power (SOP), a state of energy (SOE), a state of temperature (SOT), a state of balance (SOB), a state of life (SOL), and a state of safe (SOS).

The battery may be a removable battery, and the second accelerator signal may be a voltage or a current.

In another general aspect, a battery management system managing a battery of an electric vehicle may be configured to monitor state information of the battery; receive, from the accelerator pedal, a first accelerator signal corresponding to a force applied to an accelerator pedal by a driver of the electric vehicle; and allow a motor control unit (MCU) of the electric vehicle to generate a second accelerator signal used to control driving of the electric vehicle based on the first accelerator signal and transmit the generated second accelerator signal to the motor control unit.

The battery management system may be configured to determine whether an output of the battery corresponding to the first accelerator signal damages the battery; and generate and transmit the second accelerator signal to an MCU of the electric vehicle in response to determining that the output of the battery corresponding to the first accelerator signal damages the battery.

The battery management system may generate the second accelerator signal based on the state information of the battery.

In still another general aspect, an electric vehicle control system may include: a battery management system configured to receive a first accelerator signal corresponding to a force applied to an accelerator pedal by a driver of the electric vehicle from the accelerator pedal of the electric vehicle and generate a second accelerator signal based on the first accelerator signal and state information of a battery of the electric vehicle; and a motor control unit configured to receive the second accelerator signal from the battery management system, and receive an output for controlling driving of the electric vehicle from the battery of the electric vehicle based on the second accelerator signal.

In yet another general aspect, a method of controlling an electric vehicle may include: receiving, by a battery management system of a removable battery, a first accelerator signal from an accelerator pedal; generating, by the battery management system, a second accelerator signal based on the first accelerator signal; transmitting, by the battery management system, the second accelerator signal to a control unit; and controlling, by the control unit, a motor of the electric vehicle and adjusting an output of the battery based on a second accelerator signal.

The first accelerator signal and the second accelerator signal may be the same type of signals.

The second accelerator signal may be smaller than the first accelerator signal.

The battery management system may generate the second accelerator signal based on state information of the battery.

The second accelerator signal may be a voltage or a current.

The generating of the second accelerator signal based on the first accelerator signal may include: determining whether the output of the battery corresponding to the first accelerator signal damages the battery; and generating the second accelerator signal in response to determining that the output of the battery corresponding to the first accelerator signal damages the battery.

The generating of the second accelerator signal based on the first accelerator signal may include: generating an output value of the battery corresponding to the first accelerator signal; generating a maximum output value of the battery based on the state of the battery; comparing the output value of the battery corresponding to the first accelerator signal with the maximum output value; and generating the second accelerator signal in response to determining that the maximum output value is smaller than the output value of the battery corresponding to the first accelerator signal.

### BRIEF DESCRIPTION OF THE DRAWINGS

FIG. 1 is a block diagram of a conventional electric vehicle control system.

FIG. 2 is a block diagram of an electric vehicle control system according to an embodiment of the present disclosure.

FIG. 3 is a block diagram of the electric vehicle control system according to the embodiment of the present disclosure.

FIG. 4 is a flowchart of a method of controlling an electric vehicle motor according to an embodiment of the present disclosure.

FIG. 5 is a flowchart of the method of controlling an electric vehicle motor according to the embodiment of the present disclosure.

FIG. 6 is a flowchart of the method of controlling an electric vehicle motor according to the embodiment of the present disclosure.

### DETAILED DESCRIPTION OF EMBODIMENTS

Hereinafter, the present disclosure will be described in detail with reference to the drawings. In describing the present disclosure, when it is decided that a detailed description for the known functions or configurations related to the present disclosure may unnecessarily obscure the gist of the present disclosure, the detailed description therefor will be omitted. In addition, the following embodiments may be modified in several different forms, and the scope and spirit of the present disclosure are not limited to the following embodiments. Rather, these embodiments make the present disclosure thorough and complete, and are provided to completely transfer the spirit of the present disclosure to those skilled in the art.

However, it is to be understood that technologies mentioned in the present disclosure are not limited to specific embodiments, but include all t modifications, equivalents, and substitutions according to embodiments of the present disclosure.

Throughout the accompanying drawings, similar components will be denoted by similar reference numerals.

In the disclosure, an expression “have,” “may have,” “include,” “may include,” or the like, indicates existence of a corresponding feature (for example, a numerical value, a function, an operation, a component such as a part, or the like), and does not exclude existence of an additional feature. In the disclosure, an expression “A or B,” at least one of “A or/and B,” “one or more of A or/B,” or the like, may include all possible combinations of items enumerated together. For example, “A or B,” “at least one of A and B,” or “at least one of A or B” may indicate all of 1) a case in which at least one A is included, 2) a case in which at least one B is included, or 3) a case in which both of at least one A and at least one B are included.

Expressions “first”, “second”, “1st”, “2nd”, or the like, used in the present disclosure may indicate various components regardless of a sequence and/or importance of the components, will be used only in order to distinguish one component from the other components, and do not limit the corresponding components.

When it is mentioned that any component (for example: a first component) is (operatively or communicatively) coupled with/to or is connected to another component (for example: a second component), it is to be understood that any component is directly coupled to another component or may be coupled to another component through the other component (for example: a third component). On the other hand, when it is mentioned that any component (for example, a first component) is “directly coupled” or “directly connected” to another component (for example, a second component), it is to be understood that the other component (for example, a third component) is not present between any component and another component.

An expression “˜configured (or set) to” used in the disclosure may be replaced by an expression “suitable for,” “having the capacity to,” “˜designed to,” “˜adapted to,” “˜made to,” or “˜capable of” depending on a situation. The term “˜configured (or set) to” may not necessarily mean “specifically designed to” in hardware. Instead, an expression “˜an apparatus configured to” may mean that the apparatus “is capable of” together with other apparatuses or components. For example, a “processor configured (or set) to perform A, B, and C” or “module configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory apparatus.

The related literature described in the present disclosure is s incorporated in its entirety into this disclosure. However, the present disclosure is not limited to the contents of the related literature described in the present disclosure.

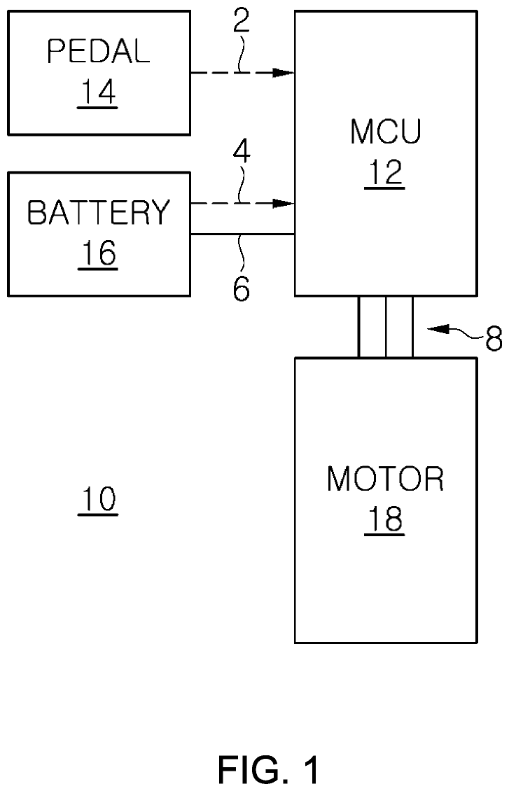

FIG. 1 is a block diagram of a conventional electric vehicle control system 10.

Referring to FIG. 1, an electric vehicle control system 10 includes an MCU 12, a pedal 14, a battery 16, and a motor 18. In one embodiment, the MCU 12 may include a vehicle control unit (VCU). In one embodiment, the MCU 12 may include an electric power control unit (EPCU). The MCU 12 may convert DC power 6 received from a battery 16 into three-phase AC power 8 and control the three-phase AC power 8 to drive the motor 18.

The MCU 12 may receive a user (or a driver) request from the pedal 14. For example, the user request may be deceleration, acceleration, etc., according to an operation of the pedal 14. Although illustrated as a pedal 14 in FIG. 1, it will be understood that the vehicle information or the user request (e.g., accelerator pedal, brake pedal, transmission, air conditioner control, etc.) is transmitted to the MCU 12. The vehicle information or the user request can be transmitted to the MCU using CAN communication protocol 2. Also, the MCU 12 may receive battery information and DC information from the battery 16. Typically, the MCU 12 may use CAN communication protocol 4 to receive a state of a battery including information of the battery 16, for example, SOC, and the like. The MCU 12 may be configured to perform motor 18 control, regenerative braking control, air conditioning load control, electrical control, analog/digital signal processing and diagnosis, and the like.

The battery 16 is a concept including a battery cell and a battery pack. In addition, the battery 16 may include a BMS. The BMS includes systems that maximize battery life and ensure safety and performance under a variety of battery charge/discharge and environmental conditions. The BMS may be configured to store a state of health (SOH), a state of charge (SOC), a state of power (SOP), a state of energy (SOE), a state of temperature (SOT), a state of balance (SOB), a state of life (SOL), a state of safe (SOS), and the like of the battery 16.

The motor 18 is configured to provide power to wheels of a vehicle.

In one embodiment, the pedal 14 may be an accelerator pedal. The accelerator pedal may include a potentiometer type or a hall sensor type. A wiper signal of the pedal 14 may be changed based on a force with which a user steps on the pedal 14. The pedal 14 may generate a resistance in a predetermined range (e.g., 0 to 5 kohm), a voltage in a predetermined range (e.g., 0 to 5 V), or a signal representing the same according to the wiper signal and transmit the signal to the MCU 12. The MCU 12 may control the motor 18 based on the received resistance or voltage. Alternatively, the pedal 14 may transmit the wiper signal to the MCU 12, and the MCU 12 may generate the resistance in the predetermined range (e.g., 0 to 5 kohm) or the voltage in the predetermined range (e.g., 0 to 5 V) based on the wiper signal and use the generated resistance and voltage to control the motor 18. For example, when the wiper signal become relatively large (the user strongly steps on or applies relatively strong force to the pedal 14), a relatively large power output may be requested from the battery and the motor 18 may be controlled quickly.

The MCU 12 may be configured to receive a maximum current value (or power value) from the battery 16 according to a power map or SOC included in the battery 16, and limit and adjust the maximum output of the battery 16 for each situation. The MCU 12 and the battery 16 may communicate with each other using a communication method such as CAN. As such, the conventional electric vehicle control system 10 is configured to receive a signal from the pedal 14 and receive a power map or the like from the BMS of the battery 16 to perform derating.

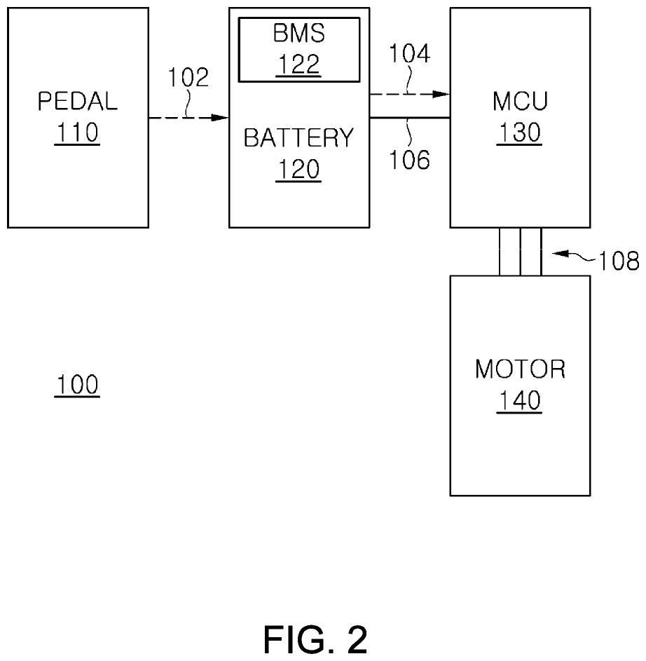

FIG. 2 is a block diagram of an electric vehicle control system 100 according to an embodiment of the present disclosure. In the electric vehicle including the electric vehicle control system 100 illustrated in FIG. 2, the MCU 130 may receive an output control signal for controlling the output of the battery 120 from the BMS 122 of the battery 120. In one embodiment, even if the user relatively strongly steps on the accelerator pedal to accelerate the electric vehicle, the BMS 122 may adjust the output of the battery more slowly than the user intends according to the state of the battery.

Referring to FIG. 2, the electric vehicle control system 100 includes a pedal 110, a battery 120, an MCU 130, and a motor 140. In one embodiment, unless otherwise stated, the pedal 110, the battery 120, the MCU 130, and the motor 140 are similar to the pedal 14, the battery 16, the MCU 12, and the motor 18, respectively, and the same description will be omitted. Hereinafter, unique features of the pedal 110, the battery 120, the MCU 130, and the motor 140 will be described. FIG. 2 illustrates signal transmission as a dotted line and output transmission as a solid line to distinguish between signal transmissions 102 and 104 and output (or current, voltage, etc.,) transmissions 106 and 108 of the battery 120, for illustrative purposes only. The battery 120 may include the BMS 122.

In one embodiment, the pedal 110 is configured to detect a stress (or a force) that a user transmits (or applies) to the pedal 110. For example, the pedal 110 may include a potentiometer type or a hall sensor type sensor. It will be appreciated that this is only an example, and other sensors may detect the stress (or a force) that the user transmits to the pedal 110. In one embodiment, the pedal 110 may generate an output signal according to the stress (or a force) transmitted to the pedal 110. For example, the pedal 110 may generate the wiper signal and transmit the generated wiper signal to the battery 120 (or BMS 122). In one embodiment, the signal from the pedal 110 may be transmitted to the battery 120 over a wire 102. In one embodiment, the pedal 110 may convert the wiper signal to form a new type of signal. The signal generated by the pedal 110 may include an analog signal or a digital signal.

In one embodiment, the battery 120 is configured to receive a signal from the pedal 110. The BMS 122 of the battery 120 is configured to receive the signal from the pedal 110. The BMS 122 may receive a signal in a predetermined range (e.g., 0 to 5 kohm, or 0 to 5 V) according to the stress (or a force) applied to the pedal 110 by the user. The battery 120 may include a removable battery. The removable battery may not be able to communicate with the MCU 130 through the standard protocol such as the CAN. Therefore, the removable battery may not be able to transmit the state information of the battery 120, such as SOC, to the MCU 130.

The BMS 122 may generate and transmit an output control signal to the MCU 130. The BMS 122 (or a storage device (not illustrated) of the battery 120) may store the state information of the battery 120. The BMS 122 may predict or determine an allowable maximum output (voltage, current, or power) according to the state information based on the state information of the battery 120. Accordingly, the BMS 122 may determine the output control signal for determining the allowable maximum output according to the state information of the battery 120 and transmit the determined output control signal to the MCU 130.

In one embodiment, the BMS 122 may generate the output control signal based on the signal received from the pedal 110 and the state information of the battery 120. Also, the BMS 122 may generate the output control signal based on the state information of the battery 120. The state information of the battery 120 may include at least one of the power map, SOC, SOH, SOP, SOE, SOT, SOB, SOL, and SOS. The BMS 122 may generate the output control signal to protect the battery 120. The BMS 122 may gradually reduce the output control signal when the state of the battery 120 approaches a limit value, for example, when the output approaches 0 according to the SOC, and may finally transmit or may not transmit the output control signal as 0. The fact that the BMS 122 transmits or does not transmit the output control signal as 0 is recognized as the same as the situation in which the user takes off the pedal 110 even if the user steps on the pedal 110 from the viewpoint of the MCU 130. In this case, there will be no additional consumption of the battery 120. When the electric vehicle stops, a relay may be opened to disconnect the battery.

In one embodiment, the BMS 122 may measure an output (e.g., current or voltage) value of the MCU 130 in real time through a sensor (e.g., a current sensor). The BMS 122 may monitor the output (e.g., output from the MCU 130 to the motor 140) of the MCU 130. The output of the battery 120 may be changed according to the output of the MCU 130. Accordingly, the BMS 122 may monitor the output of the MCU 130, determine the output control signal in consideration of the state of the battery 120, and transmit the determined output control signal to the MCU 130.

In one embodiment, the output control signal generated by BMS 122 and transmitted to MCU 130 may be simpler than the CAN protocol. For example, the output control signal generated by the BMS 122 may be a signal (e.g., a wiper signal, a voltage, a current, etc.) of the same shape/type as the signal generated by the pedal 110. For example, the output control signal generated by BMS 122 may include a new wiper signal. In one embodiment, the output control signal may be the same signal that the BMS 122 receives from the pedal 110. For example, when the BMS 122 receives n V or n A (where n is a real number greater than or equal to 0), the BMS 122 may transmit the same n V or n A to MCU 130. In one embodiment, the output control signal may be a different signal that the BMS 122 receives from the pedal 110. For example, when the BMS 122 receives n V or n A, the BMS 122 may transmit a different m V or m A (where m is a real number greater than or equal to 0) to the MCU 130. For example, the output control signal generated by the BMS 122 may be less than the signal received by the BMS 122.

In one embodiment, the BMS 122 may receive an analog signal from the pedal 110 and convert the received analog signal into a digital signal. To this end, the BMS 122 may include an analog to digital converter (ADC). The BMS 122 may predict/determine an output (current or voltage) to be supplied by the battery 120 based on the signal received from the pedal 110 or the converted digital signal. For example, when an output corresponding to a signal received from the pedal 110 is output, it may be determined whether or not the battery 120 is damaged. When the battery 120 predicts/determines that the power to be supplied is greater than the allowable power of the battery 120 which may damage the battery 120, the BMS 122 may generate the output control signal different from the signal received from the pedal 110 and transmit the generated output control signal to the MCU 130. The output requested by the MCU 130 to the battery 120 according to an output control signal different from the signal received from the pedal 110 may be an output that does not damage the battery 120. For example, the output control signal different from the signal received from the pedal 110 may be a signal having a smaller magnitude than that of the signal received from the pedal 110. In one embodiment, the BMS 122 may convert the digital signal into the analog signal and transmit the analog signal to the MCU 130. To this end, the BMS 122 may include a digital to analog converter (DAC).

In one embodiment, the BMS 122 may set a maximum value that the battery 120 may output without damaging the battery 120. The BMS 122 may set a maximum output value of the battery 120 based on the state information of the battery 120 and/or a current battery state. The BMS 122 may calculate/predict/determine the output control signal corresponding to the set maximum output value. The BMS 122 may compare the output of the battery 120 according to the signal received from the pedal 110 with the set maximum output value. In response to determining that the output of the battery 120 according to the signal received from the pedal 110 is greater than the set maximum output value, the BMS 122 may transmit the output control signal corresponding to the set maximum output value to the MCU 130. In response to determining that the output of the battery 120 according to the signal received from the pedal 110 is greater than the set maximum output value, the BMS may transmit the output control signal to the MCU 130 to output an output smaller than the set maximum output value.

In response to determining that the output of the battery 120 according to the signal received from the pedal 110 is smaller than the set maximum output value, the BMS 122 may transmit the received signal to the MCU 130.

In one embodiment, the BMS 122 may transmit the signal received from the pedal 110 to the MCU 130 as it is, or the BMS 122 may change the magnitude of the signal received from the pedal 110 and transmit the changed signal to the MCU 130.

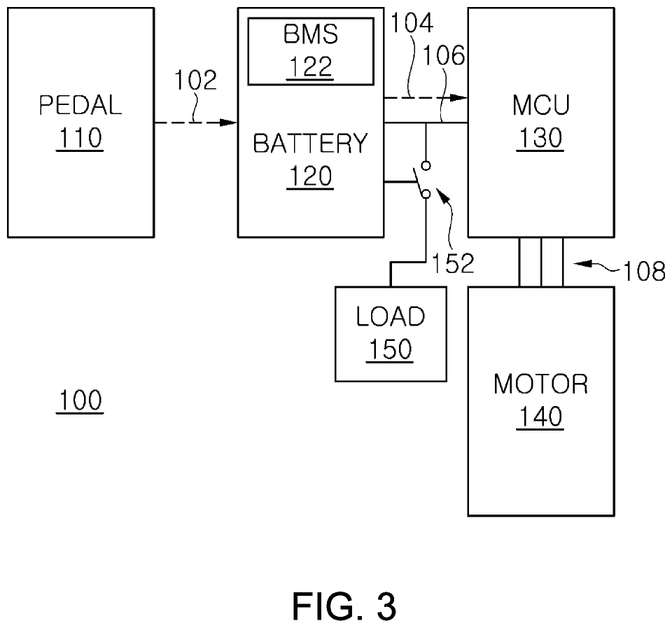

FIG. 3 is a block diagram of the electric vehicle control system 100 according to an embodiment of the present disclosure. Referring to FIG. 3, the electric vehicle control system 100 further includes a load 150 and a switch 152. The load may be connected, through the switch 152, to a line 106 through which the output of the battery 120 is transmitted to the MCU 130. The switch 152 may be on/off controlled by the BMS 122. When the switch 152 is turned on, energy is consumed in the load 150, and accordingly, the output transmitted from the battery 120 to the MCU 130 may be reduced or the output transmitted from the MCU 130 to the battery 120 may be reduced.

The MCU 130 may control the motor 140 based on the output control signal received from the battery 120. In one embodiment, the MCU 130 may include an inverter (not illustrated). The inverter may control the torque of the motor by converting the DC voltage of the battery into an AC voltage 108 having a variable frequency and voltage level required for driving the motor. The MCU 130 may request an output from the battery 120 and receive an output from the battery 120. The MCU 130 may receive the output from the battery 120 based on the output control signal received from the battery 120.

According to the conventional electric vehicle control system 10, the wiper signal is generated in response to the force with which the user steps on the pedal 14, and the MCU 12 may receive the output from the battery 16 based on the wiper signal corresponding to the force with which the user steps on the pedal 14. That is, for example, the conventional electric vehicle control system 10 makes a current flow from the battery 16 to the MCU 12 in proportion to the force with which the user steps on the pedal 14. Here, the MCU 12 may receive the information of the battery 16, for example, receive the battery state including SOC, etc., by using the CAN communication protocol 4 and derate the current from the battery 16 to the MCU 12. This is possible because the MCU 12 and the battery 16 use the CAN communication protocol 4. When it is assumed that the battery 16 of the conventional electric vehicle control system 10 is a removable type, the CAN communication is difficult between the electric vehicle control system 10 and the battery 16, and therefore, the MCU 12 may not obtain the information of the battery 16, so the derating will be impossible.

On the other hand, according to the present disclosure, the battery 120 of the electric vehicle control system 100 can control the output control signal of the battery 120 transmitted to the MCU 130 according to the state of the battery 120. The MCU 130 may receive the output from the battery 120 based on the output control signal received from the battery 120. Therefore, the same effect as the derating may be created so that an appropriate output is made according to the state of the battery 120.

Therefore, even if the user strongly steps on the pedal 110, the battery 120 can adjust the rising curve of the accelerator signal according to the state of the battery 120 so that the excessive pickup current does not flow, and the accelerator signal may be continuously adjusted so that the discharged current does not exceed the state map of the battery 120, such as SOC.

In one embodiment, when the amount of charge of the battery 120 falls below a predetermined value (e.g., 10%, 20%, 30%, etc.), the BMS 122 may transmit the output control signal to the MCU 130 with a preset value (e.g., X % of the signal input from the pedal 110, a signal for low-speed control, a preset low speed output curve (or table), etc.).

In one embodiment, when the temperature of the battery 120 is a predetermined value (e.g., when the temperature is too high or low, or the like), the BMS 122 may transmit the output control signal to the MCU 130 with a preset value (e.g., X % of the signal input from the pedal 110, a signal for low-speed control, a preset low speed output curve (or table), etc.).

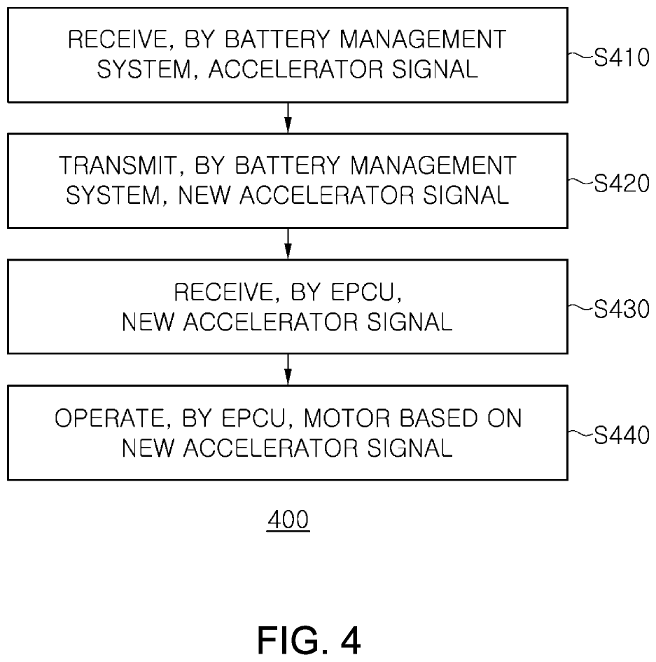

FIG. 4 is a flowchart of a method 400 of controlling an electric vehicle motor according to the embodiment of the present disclosure. Referring to FIG. 4, it will be understood that the method 400 of controlling an electric vehicle motor may be performed by the electric vehicle control system illustrated in FIG. 2. However, it will be understood that the method illustrated in FIG. 4 may also be used for an electric vehicle control system different from the electric vehicle control system illustrated in FIG. 2. In FIG. 4, it is shown that the EPCU operates the motor 140 instead of the MCU 130, and it will be understood that this is obvious to those skilled in the art.

Referring to FIG. 4, in block S410, the battery management system receives an accelerator signal. The battery management system may receive the accelerator signal from the accelerator pedal. The accelerator signal may be generated in response to the force with which the driver steps on the accelerator pedal. The accelerator signal from the accelerator pedal may be in the form of the current or voltage. In block S420, the battery management system generates a new accelerator signal separately from the signal received from the accelerator pedal and transmits the accelerator signal to the EPCU. The new accelerator signal may be the same as or different from the accelerator signal from the accelerator pedal. The type of the new accelerator signal may be the same as or different from the accelerator signal from the accelerator pedal. In one embodiment, the output of the battery corresponding to the new accelerator signal may be smaller than the output of the battery corresponding to the accelerator signal from the accelerator pedal. The battery management system may generate a new accelerator signal based on the battery state information. The output corresponding to the new accelerator signal may include an output within a range that does not damage the battery. The new accelerator signal is a different type from the CAN communication protocol. The new accelerator signal may be in the form of the current or voltage. In block S430, the EPCU receives a new accelerator signal. In block S440, the EPCU operates the motor based on the new accelerator signal. When the EPCU operates the motor based on the new accelerator signal, the EPCU may receive the output corresponding to the new accelerator signal from the battery.

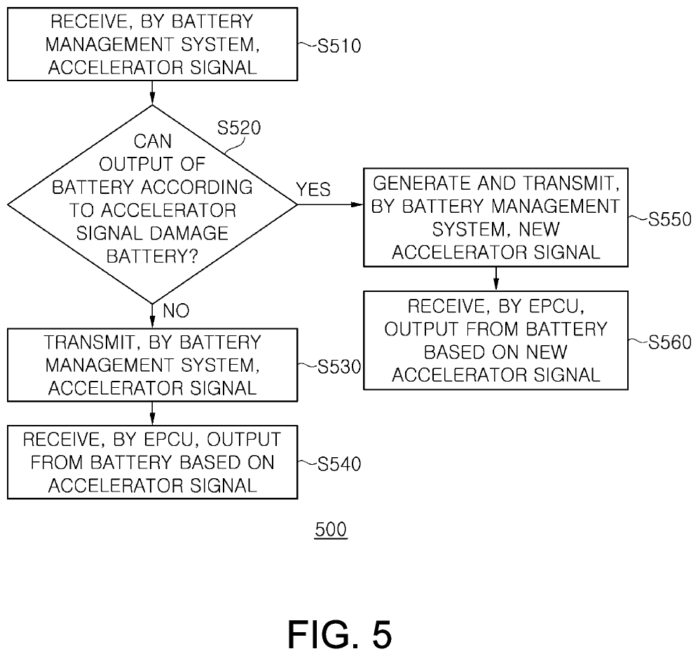

FIG. 5 is a flowchart of a method 500 of controlling an electric vehicle motor according to the embodiment of the present disclosure. Referring to FIG. 5, it will be understood that the method 500 of controlling an electric vehicle motor may be performed by the electric vehicle control system illustrated in FIG. 2. However, it will be understood that the method illustrated in FIG. 5 may also be used for an electric vehicle control system different from the electric vehicle control system illustrated in FIG. 2. In FIG. 5, it is shown that the EPCU operates the motor 140 instead of the MCU 130, and it will be understood that this is obvious to those skilled in the art.

Referring to FIG. 5, in block S510, the battery management system receives an accelerator signal. The battery management system may receive the accelerator signal from the accelerator pedal. The accelerator signal may be generated in response to the force with which the driver steps on the accelerator pedal. The accelerator signal from the accelerator pedal may be in the form of the current or voltage.

In block S520, the battery management system determines whether the output of the battery according to the accelerator signal may damage the battery. The battery management system may determine whether the output of the battery according to the accelerator signal may damage the battery based on the state information of the battery. For example, the battery management system may determine whether the output of the battery according to the accelerator signal may damage the battery based on at least one of the temperature of the battery, the remaining capacity of the battery, the number of times the battery is recharged, the state of the battery cell, and the like.

In response to determining in block S520 that the output of the battery according to the accelerator signal does not damage the battery, in block S530, the battery management system transmits the accelerator signal to the EPCU. In one embodiment, the accelerator signal transmitted from the battery management system to the EPCU may be the same as the accelerator signal received in S510. In one embodiment, the accelerator signal transmitted from the battery management system to the EPCU may be the same signal as the accelerator signal received in S510 that is generated and transmitted by the battery management system. The accelerator signal transmitted from the battery management system to the EPCU may be the same as or different from the accelerator signal from the accelerator pedal. The type of the accelerator signal transmitted from the battery management system to the EPCU may be the same as or different from the type of the accelerator signal from the accelerator pedal.

In block 540, the EPCU receives the output from the battery based on the accelerator signal transmitted from the battery management system to the EPCU. The EPCU may drive the motor using the output from the battery.

In response to determining in block S520 that the output of the battery according to the accelerator signal damages the battery, in block S550, the battery management system generates a new accelerator signal and transmits the new accelerator signal to the EPCU. The type of the new accelerator signal may be the same as or different from the accelerator signal from the accelerator pedal. In one embodiment, the output of the battery corresponding to the new accelerator signal may be smaller than the output of the battery corresponding to the accelerator signal from the accelerator pedal. The battery management system may generate a new accelerator signal based on the battery state information. The output corresponding to the new accelerator signal may include an output within a range that does not damage the battery. The new accelerator signal is a different type from the CAN communication protocol. The new accelerator signal may be in the form of the current or voltage.

In block S560, the EPCU receives the output from the battery based on the new accelerator signal. The EPCU may drive the motor using the output from the battery.

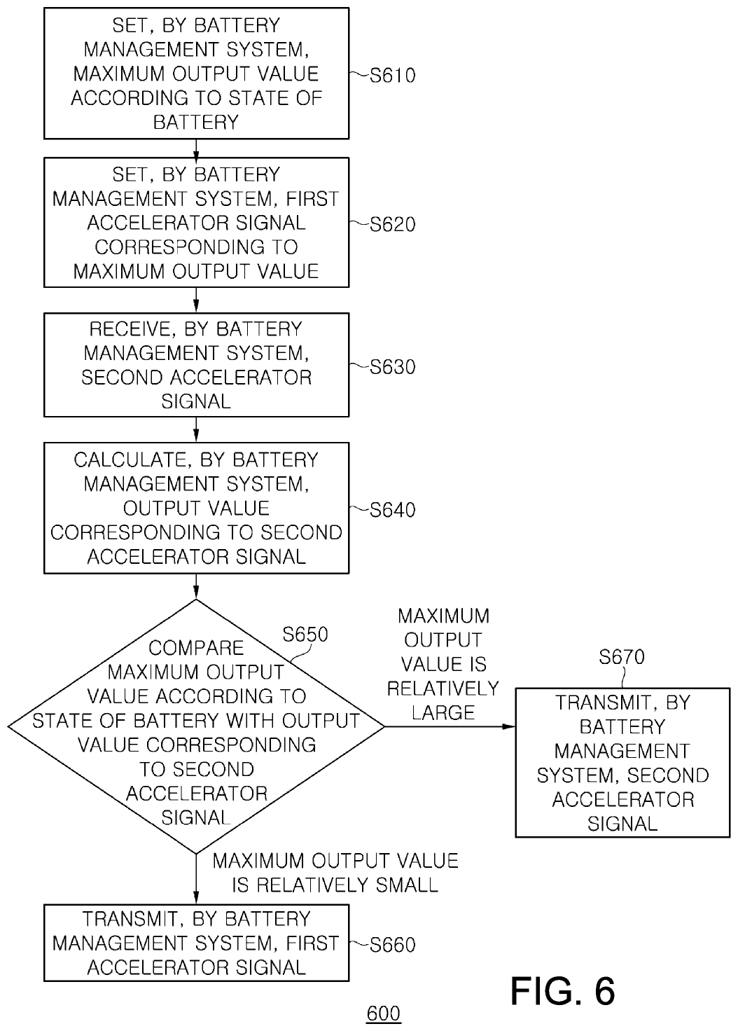

FIG. 6 is a flowchart of a method 600 of controlling an electric vehicle motor according to the embodiment of the present disclosure. Referring to FIG. 6, it will be understood that the method 600 of controlling an electric vehicle motor may be performed by the electric vehicle control system illustrated in FIG. 2. However, it will be understood that the method illustrated in FIG. 6 may also be used for an electric vehicle control system different from the electric vehicle control system illustrated in FIG. 2. In FIG. 6, it is shown that the EPCU operates the motor 140 instead of the MCU 130, and it will be understood that this is obvious to those skilled in the art.

In block S610, the battery management system may set the maximum output value of the battery according to the battery state. For example, the battery management system may set the maximum output value that does not damage the battery based on at least one of the temperature of the battery, the remaining capacity of the battery, the number of times the battery is charged, the state of the battery cell, and the like. In one embodiment, the battery management system may set the maximum output value that does not damage the battery based on a table in which maximum outputs related to the temperature of the battery, the remaining capacity of the battery, the number of times the battery is charged, the state of the battery cell, and the like are determined.

In block S620, the battery management system may set the second accelerator signal corresponding to the maximum output value.

In block S630, the battery management system receives the second accelerator signal. The battery management system may receive the second accelerator signal from the accelerator pedal. The second accelerator signal may be generated in response to the force with which the driver steps on the accelerator pedal. The second accelerator signal from the accelerator pedal may be in the form of the current or voltage.

In block S640, the battery management system calculates the output value of the battery corresponding to the second accelerator signal.

In one embodiment, it will be understood that blocks S630 and S640 may precede blocks S610 and S620.

In block S650, the maximum output value and the output value of the battery corresponding to the second accelerator signal are compared.

In block S650, in response to determining that the maximum output value is smaller than the output value of the battery corresponding to the second accelerator signal, in block S660, the battery management system transmits the first accelerator signal to the EPCU. Alternatively, the battery management system may transmit a signal smaller than the first accelerator signal to the EPCU. The EPCU receives the output from the battery based on the first accelerator signal (or a smaller signal). The EPCU may drive the motor using the output from the battery.

In block S650, in response to determining that the maximum output value is greater than the output value of the battery corresponding to the second accelerator signal, in block S670, the battery management system transmits the second accelerator signal to the EPCU. The EPCU receives the output from the battery based on the second accelerator signal. The EPCU may drive the motor using the output from the battery.

Typically, in the electric vehicle, the electric vehicle control system may determine the output (e.g., current, voltage, etc.) required by the load (e.g., MCU, motor, etc.) from the battery in consideration of factors other than the signal from the accelerator pedal. Although the present disclosure has been described as receiving, by the BMS, the signal from the pedal and generating the output control signal using the state information of the battery, it will be appreciated that other elements may also be used to generate the output control signal. It will also be appreciated that the MCU may receive the output control signal and further consider other factors to determine the required output of the battery.

In the present disclosure, it will be appreciated that the MCU is used as a term referring to a component that controls the power system of the vehicle.

In the present disclosure, it is used for explanation that the MCU requests an output from the battery. It will be appreciated that the concept includes not only actually transmitting, by the MCU, some output signal and transmitting, by the battery, the output to the MCU in response to the output signal, but also pulling, by the MCU, the required output from the battery.

As an embodiment, the MCU and/or battery management system of the present disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and any type of processor or controller for performing other functions.

In one embodiment, the electric vehicle control system 100 of the present disclosure may further include a storage device configured to store information. The storage device may store a plurality of application programs or applications that are driven in the electric vehicle control system 100, data readable by a processor, and instructions. For example, the storage device may include various storage spaces such as a hard disk drive (HDD), a solid state disk (SSD), a silicon disk drive (SDD), a ROM, a RAM, an EPROM, a flash drive, a hard drive, and a cloud using a network.

In one embodiment, the electric vehicle control system 100 of the present disclosure may be configured to communicate with an external device through a network. The communication method of the network may use networks constructed according to Global System for Mobile communication (GSM), Code Division Multi Access (CDMA), High Speed Downlink Packet Access (HSDPA), High Speed Uplink Packet Access (HSDPA), Long Term Evolution (LTE), Long Term Evolution-Advanced (LTE-A), Wireless LAN (WLAN), Wireless-Fidelity (Wi-Fi), Wireless Fidelity (Wi-Fi) Direct, Digital Living Network Alliance (DLNA), Wireless Broadband (WiBro), and World Interoperability for Microwave Access (WiMAX), etc., but is not limited thereto and may include all transmission standards to be developed in the future. In addition, the communication method of the network may include all of those capable of exchanging data through the wired/wireless communication.

The device and method described hereinabove may be implemented by hardware components, software components, and/or combinations of hardware components and software components. For example, the devices and the components described in the embodiments may be implemented using one or more general purpose computers or special purpose computers such as a processor, a controller, an arithmetic logic unit (AUL), a digital signal processor, a microcomputer, a field programmable gate array (FPGA), a programmable logic unit (PLU), a microprocessor, or any other devices that may execute instructions and respond to the instructions. A processing device may execute an operating system (OS) and one or more software applications executed on the operating system. In addition, the processing device may access, store, manipulate, process, and create data in response to execution of software. Although a case in which one processing device is used is described for convenience of understanding, it may be recognized by those skilled in the art that the process device may include a plurality of processing elements and/or plural types of processing elements. For example, the processing device may include a plurality of processors or one processor and one controller. In addition, other processing configurations such as parallel processors are also possible.

The software may include computer programs, codes, instructions, or a combination of one or more thereof, and may configure the processing device to be operated as desired or independently or collectively command the processing device to be operated as desired. The software and/or the data may be permanently or temporarily embodied in any type of machine, component, physical device, virtual equipment, computer storage medium or device, or transmitted signal wave to be interpreted by the processing device or provide instructions or data to the processing device. The software may be distributed on computer systems connected to each other by a network to be thus stored or executed by a distributed method. The software and the data may be stored in one or more computer-readable recording media.

The embodiments described in the present disclosure may also be practiced in distributed computing environments where certain tasks are performed by remote processing devices that are linked through a communications network. In a distributed computing environment, program modules may be located in both local and remote memory storage devices.

The methods according to the embodiment may be implemented in a form of program commands that may be executed through various computer means and may be recorded in a computer-readable recording medium. The computer-readable recording medium may include a program command, a data file, a data structure, or the like, alone or a combination thereof. The program commands recorded in the computer-readable recording medium may be especially designed and configured for the embodiments or be known to those skilled in a field of computer software. Examples of the computer-readable recording medium may include a magnetic medium such as a hard disk, a floppy disk, or a magnetic tape; an optical medium such as a compact disk read only memory (CD-ROM) or a digital versatile disk (DVD); a magneto-optical medium such as a floptical disk; and a hardware device specially configured to store and execute program commands, such as a ROM, a RAM, a flash memory, or the like. Examples of the program commands include a high-level language code capable of being executed by a computer using an interpreter, or the like, as well as a machine language code made by a compiler. The abovementioned hardware device may be constituted to be operated as one or more software modules to perform the operations of the embodiments, and vice versa.

A computing device may operate in a networked environment using logical connections to one or more remote computers, such as remote computer (s) via wired and/or wireless communications. The remote computer (s) may be workstations, server computers, routers, personal computers, handheld computers, microprocessor-based entertainment devices, peer devices, or other common network nodes, and typically include many or all of the components described for computing devices. A logical connection includes a wired/wireless connection to a local area network (LAN) and/or a larger network, such as a wide area network (WAN). Such LAN and WAN networking environments are common in offices and corporations and facilitate enterprise-wide computer networks, such as intranets, all of which may be connected to worldwide computer networks, such as the Internet.

In an electric vehicle where a battery has been replaced, in a situation where relatively complex communication between a BMS and an MCU may not be implemented, for example, in an electric vehicle without a CAN communication function between the battery and the MCU, the electric vehicle can be controlled to have the same effect as the derating.

As described above, although the embodiments have been described by the limited drawings, various modifications and alternations are possible by those of ordinary skill in the art from the above description. For example, even though the described techniques may be performed in a different order than the described method, and/or components of the described systems, structures, devices, circuits, etc., may be combined or combined in a different manner than the described method, or replaced or substituted by other components, appropriate results may be achieved.

Therefore, other implementations, other embodiments, and equivalents of the claims are within the scope of the following claims.

What is claimed is:

1. An electric vehicle, comprising:
a motor for driving the electric vehicle;
an accelerator pedal configured to receive a force from a driver and generate a first accelerator signal corresponding to the force;
a battery configured to drive the motor, the battery including a battery management system configured to receive the first accelerator signal from the accelerator pedal and generate a second accelerator signal; and
a control unit configured to receive the second accelerator signal from the battery management system, and to control the motor and adjust an output of the battery based on the second accelerator signal.

2. The electric vehicle of claim 1, wherein the first accelerator signal and the second accelerator signal are the same type of signals.

3. The electric vehicle of claim 1, wherein the second accelerator signal is smaller than the first accelerator signal.

4. The electric vehicle of claim 1, wherein the battery management system generates the second accelerator signal based on state information of the battery.

5. The electric vehicle of claim 4, wherein the state information of the battery includes at least one of a state of health (SOH), a state of charge (SOC), a state of power (SOP), a state of energy (SOE), a state of temperature (SOT), a state of balance (SOB), a state of life (SOL), and a state of safe (SOS).

6. The electric vehicle of claim 1, wherein the battery is a removable battery, and
the second accelerator signal is a voltage or a current.

7. A battery management system for managing a battery of an electric vehicle, wherein the battery management system is configured to:
monitor state information of the battery;
receive, from the accelerator pedal, a first accelerator signal corresponding to a force applied to an accelerator pedal by a driver of the electric vehicle; and
allow a motor control unit (MCU) of the electric vehicle to generate a second accelerator signal used to control driving of the electric vehicle based on the first accelerator signal and transmit the generated second accelerator signal to the motor control unit.

8. The battery management system of claim 7, wherein the battery management system is configured to:
determine whether an output of the battery corresponding to the first accelerator signal damages the battery; and
generate and transmit the second accelerator signal to an MCU of the electric vehicle in response to determining that the output of the battery corresponding to the first accelerator signal damages the battery.

9. The battery management system of claim 7, wherein the battery management system generates the second accelerator signal based on the state information of the battery.

10. An electric vehicle control system, comprising:
a battery management system configured to receive a first accelerator signal corresponding to a force applied to an accelerator pedal by a driver of the electric vehicle from the accelerator pedal of the electric vehicle and generate a second accelerator signal based on the first accelerator signal and state information of a battery of the electric vehicle; and
a motor control unit configured to receive the second accelerator signal from the battery management system, and receive an output for controlling driving of the electric vehicle from the battery of the electric vehicle based on the second accelerator signal.

11. A method of controlling an electric vehicle, comprising:
receiving, by a battery management system of a removable battery, a first accelerator signal from an accelerator pedal;
generating, by the battery management system, a second accelerator signal based on the first accelerator signal;
transmitting, by the battery management system, the second accelerator signal to a control unit; and
controlling, by the control unit, a motor of the electric vehicle and adjusting an output of the battery based on a second accelerator signal.

12. The method of claim 11, wherein the first accelerator signal and the second accelerator signal are the same type of signals.

13. The method of claim 11, wherein the second accelerator signal is smaller than the first accelerator signal.

14. The method of claim 11, wherein the battery management system generates the second accelerator signal based on state information of the battery.

15. The method of claim 11, wherein the second accelerator signal is a voltage or a current.

16. The method of claim 11, wherein the generating of the second accelerator signal based on the first accelerator signal includes:
determining whether the output of the battery corresponding to the first accelerator signal damages the battery; and
generating the second accelerator signal in response to determining that the output of the battery corresponding to the first accelerator signal damages the battery.

17. The method of claim 11, wherein the generating of the second accelerator signal based on the first accelerator signal includes:
generating an output value of the battery corresponding to the first accelerator signal;
generating a maximum output value of the battery based on the state of the battery;
comparing the output value of the battery corresponding to the first accelerator signal with the maximum output value; and
generating the second accelerator signal in response to determining that the maximum output value is smaller than the output value of the battery corresponding to the first accelerator signal.
